(19) United States
(12) Patent Application Publication
(10) Pub. No.: US 2013/0089248 A1
(43) Pub. Date: Apr. 11, 2013

(54) METHOD AND SYSTEM FOR ANALYZING BIOLOGICAL SPECIMENS BY SPECTRAL IMAGING

(71) Applicant: CIRECA THERANOSTICS, LLC, Parsippany, NJ (US)

(72) Inventors: Stanley H. REMISZEWSKI, Spencer, MA (US); Clay M. Thompson, Camano Island, WA (US)

(73) Assignee: CIRECA THERANOSTICS, LLC, Parsippany, NJ (US)

(21) Appl. No.: 13/645,970

(22) Filed: Oct. 5, 2012

Related U.S. Application Data
(60) Provisional application No. 61/543,604, filed on Oct. 5, 2011.
(60) Provisional application No. 61/548,104, filed on Oct. 17, 2011.

(51) Int. Cl. G06K 9/62; G06K 9/00

(52) U.S. Cl. 382/128

(57) ABSTRACT

The methods, devices and systems may allow a practitioner to obtain information regarding a biological sample, including analytical data, a medical diagnosis, and/or a prognosis or predictive analysis. In addition, the methods, devices and systems may train one or more machine learning algorithms to perform a diagnosis of a biological sample.

### RELATED APPLICATIONS

This application claims priority to U.S. Provisional Patent Application No. 61/543,604 titled “METHOD AND SYSTEM FOR ANALYZING BIOLOGICAL SPECIMENS BY SPECTRAL IMAGING” filed Oct. 5, 2011 and U.S. Provisional Patent Application No. 61/548,104 titled “METHOD AND SYSTEM FOR ANALYZING SPECTROSCOPIC DATA TO IDENTIFY MEDICAL CONDITIONS” filed Oct. 17, 2011. This application contains subject matter related to U.S. patent application Ser. No. 13/507,386 titled “METHOD FOR ANALYZING BIOLOGICAL SPECIMENS BY SPECTRAL IMAGING” filed Jun. 25, 2012, U.S. Provisional Patent Application No. 61/322,642 titled “A TUNABLE LASER-BASED INFRARED IMAGING SYSTEM” filed Apr. 9, 2010; U.S. patent application Ser. No. 12/994,647 filed titled “METHOD OF RECONSTITUTING CELLULAR SPECTRA USEFUL FOR DETECTING CELLULAR DISORDERS” filed Feb. 17, 2011, based on Patent Cooperation Treaty (PCT) Patent Appl. No. PCT/US2009/045681 titled “METHOD OF RECONSTITUTING CELLULAR SPECTRA USEFUL FOR DETECTING CELLULAR DISORDERS” having international filing date May 29, 2009, and claiming priority to U.S. Patent Appl. No. 61/056,955 titled “METHOD OF RECONSTITUTING CELLULAR SPECTRA FROM SPECTRAL MAPPING DATA” filed May 29, 2008; U.S. Provisional Patent Appl. No. 61/358,606 titled “DIGITAL STAINING OF HISTOPATHOLOGICAL SPECIMENS VIA SPECTRAL HISTOPATHOLOGY” filed Jun. 25, 2010; to U.S. patent application Ser. No. 13/084,287 titled “TUNABLE LASER-BASED INFRARED IMAGING SYSTEM AND METHOD OF USE THEREOF” filed Apr. 11, 2011; and to U.S. patent application Ser. No. 13/067,777 titled “METHOD FOR ANALYZING SPECIMENS BY SPECTRAL IMAGING” filed Jun. 24, 2011. The entirety of each of the foregoing applications is hereby incorporated by reference herein.

### FIELD OF INVENTION

Aspects of the present invention relate to systems and methods of analysis of imaging data and assessment of imaged samples, including tissue samples to provide a medical diagnosis. More specifically, aspects of the present invention are directed to systems and methods for receiving biological sample data and providing analysis of the biological sample data to assist in medical diagnosis.

### BACKGROUND

One problem that exists in the art today is that there remains a lack of methods and systems that both improve detection of abnormalities in biological samples and deliver analytical results to a practitioner.

In the related art, a number of diseases may be diagnosed using classical cytopathology and histopathology methods involving examination of nuclear and cellular morphology and staining patterns. Typically, such diagnosis occurs via examining up to 10,000 cells in a biological sample and finding about 10 to 50 cells or a small section of tissue that may be abnormal. This finding is based on subjective interpretation of visual microscopic inspection of the cells in the sample.

An example of classical cytology dates back to the middle of the last century, when Papanicolaou introduced a method to monitor the onset of cervical disease by a test, commonly known as the “Pap” test. For this test, cells are exfoliated using a spatula or brush, and deposited on a microscope slide for examination. In the original implementation of the test, the exfoliation brush was smeared onto a microscope slide, hence the name “Pap smear.” Subsequently, the cells were stained with hematoxylin/eosin (H&E) or a “Pap stain” (which consists of H&E and several other counterstains), and were inspected visually by a cytologist or cyto-technician, using a low power microscope (see FIGS. 1A and 1B for Photostat images of an example Pap smear slide and a portion thereof under 10× microscopic magnification, respectively).

The microscopic view of such samples often shows clumping of cells and contamination by cellular debris and blood-based cells (erythrocytes and leukocytes/lymphocytes). Accordingly, the original “Pap-test” had very high rates of false-positive and false-negative diagnoses. Modern, liquid-based methods (such as cyto-centrifugation, the ThinPrep® or the Surepath® methods) have provided improved cellular samples by eliminating cell clumping and removing confounding cell types (see, e.g., example Photostat image of a 10× magnification microscopic view of a cytologocil sample prepared by liquid-based methods, shown in FIG. 2).

However, although methods for the preparation of samples of exfoliated cells on microscope slides have improved substantially, the diagnostic step of the related art still typically relies on visual inspection and comparison of the results with a data base in the cytologist's memory. Thus, the diagnosis is still inherently subjective and associated with low inter- and intra-observer reproducibility. To alleviate this aspect, other related art automated visual light image analysis systems have been introduced to aid cytologists in the visual inspection of cells. However, since the distinction between atypia and low grades of dysplasia is extremely difficult, such related art automatic, image-based methods have not substantially reduced the actual burden of responsibility on the cytologist.

Spectral methods have also been applied in the related art to the histopathological diagnosis of tissue sections available from biopsy. The data acquisition for this approach, referred to as “Spectral Histopathology (SHP),” can be carried out using the same visual light based instrumentation used for spectral cytopathology (“SCP”).

FIGS. 3A and 3B show Photostats of the results of SHP for the detection of metastatic cancer in an excised axillary lymph node using methods of the related art. FIG. 3A contains a Photostat of the H&E stained image of axillary lymph node tissue, with regions marked as follows: 1) capsule; 2) noncancerous lymph node tissue; 3) medullary sinus; and 4) breast cancer metastatis. To obtain the Photostat image shown in FIG. 3B, collected infrared spectral data were analyzed by a diagnostic algorithm, trained on data from several patients. The algorithm is subsequently able to differentiate noncancerous and cancerous regions in the lymph node. In FIG. 3B, the Photostat shows the same tissue as in FIG. 3A constructed by supervised artificial neural network trained to differentiate noncancerous and cancerous tissue only. The network was trained on data from 12 patients.

In some methods of the related art, a broadband infrared (IR) or other light output is transmitted to a sample (e.g., a tissue sample), using instrumentation, such as an interferometer, to create an interference pattern. Reflected and/or passed transmission is then detected, typically as another interference pattern. A Fast Fourier Transform (FFT) may then be performed on the detected pattern to obtain spectral information relating to the sample.

One limitation of the FFT based related art process is that the amount of energy available per unit time in each band pass may be very low, due to use of a broad spectrum transmission, which may include, for example, both IR and visible light. As a result, the data available for processing with this approach is generally inherently limited. Further, in order to discriminate the received data from background noise, for example, with such low detected energy data available, high sensitivity instruments must be used, such as high sensitivity liquid nitrogen cooled detectors (the cooling alleviates the effects of background IR interference). Among other drawbacks, such related art systems may incur great costs, footprint, and energy usage.

In one related art device produced by Block Engineering (see, e.g., J. Coates, “Next-Generation IR Microscopy: The Devil Is in the Detail,” BioPhotonics (October 2010) pp. 24-27), which proposes to use a Quantum Cascade Laser (QCL) in conjunction with a interferometric imager, no device or system has been identified to suitably coordinate operation between the QCL and the imager.

There remains an unmet need in the art for devices, methods, and systems for transmitting and detecting IR and/or other similar transmissions for use, for example, for imaging tissue samples and other samples under ambient conditions for such purposes as the diagnosis, prognosis and/or prediction of diseases and/or conditions. There also remains an unmet need in the art for systems and method for providing the analytical results to a practitioner.

### SUMMARY OF THE INVENTION

Aspects of the present invention include methods, devices, and systems for imaging tissue and other samples using IR transmissions from coherent transmission sources, such as a broad-band, tunable, quantum cascade laser (QCL) designed for the rapid collection of infrared microscopic data for medical diagnostics across a wide range of discrete spectral increments. The infrared data may be processed by an analyzer to provide analytical data, a medical diagnosis, a prognosis and/or predictive analysis.

Such methods, devices, and systems may be used to detect abnormalities in biological samples, for example, before such abnormalities can be diagnosed using related art cytopathological or histopathological methods.

The methods, devices and systems may be used to conveniently allow a practitioner to obtain information regarding a biological sample, including analytical data and/or a medical diagnosis.

The methods, devices and systems may also be used to train one or more machine learning algorithms to provide a diagnosis, prognosis and/or predictive classification of a biological sample. In addition, the methods, devices and systems may be used to generate one or more classification models that may be used to perform a medical diagnosis, prognosis and/or predictive analysis of a biological sample.

Additional advantages and novel features relating to variations of the present invention will be set forth in part in the description that follows, and in part will become more apparent to those skilled in the art upon examination of the following or upon learning by practice of aspects thereof.

### DESCRIPTION OF THE FIGURES

Aspects of the present invention will become fully understood from the detailed description given herein below and the accompanying drawings, which are given by way of illustration and example only, and thus not limited with respect to aspects thereof, wherein:

FIGS. 1A and 1B show Photostat images of an example Pap smear slide and a portion thereof under 10× microscopic magnification, respectively;

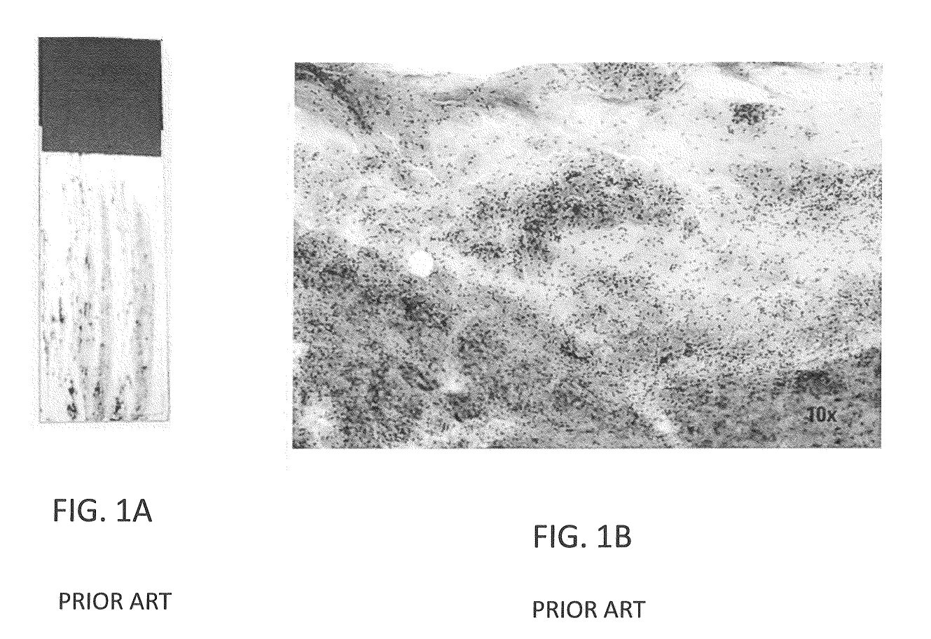

FIG. 2 shows an example Photostat image of a 10× magnification microscopic view of a cytologocil sample prepared by liquid-based methods;

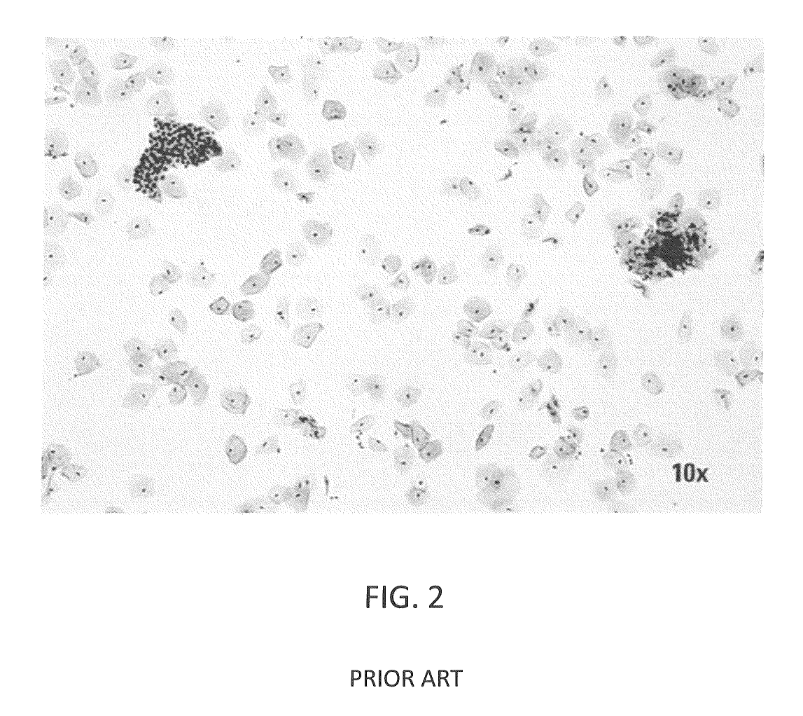

FIGS. 3A and 3B show Photostats of the results of SHP for the detection of metastatic cancer in an excised axillary lymph node;

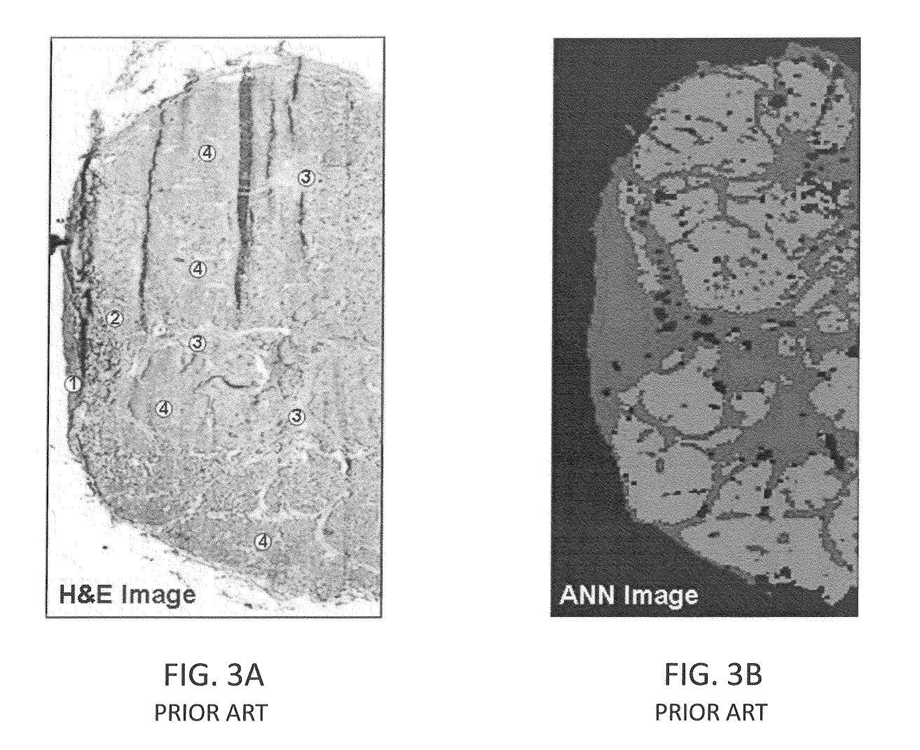

FIG. 4 shows a flowchart illustrating steps in a method of providing diagnosis information to a practitioner according to aspects of the present invention;

FIG. 5 illustrates a flowchart illustrating a method of populating a data repository in accordance with an aspect of the present invention;

FIG. 6 illustrates a flowchart illustrating a method of automatically labeling an annotation region in accordance with an aspect of the present invention;

FIG. 7 illustrates an example method for automatically selecting another annotation region in accordance with an aspect of the present invention;

FIG. 8 illustrates an example annotation file in accordance with an aspect of the present invention;

FIG. 9 illustrates an example method flow for training algorithms in accordance with an aspect of the present invention;

FIG. 10 illustrates an example method flow for creating a classification model in accordance with an aspect of the present invention;

FIG. 11 illustrates an example model for diagnosing lung cancer in accordance with an aspect of the present invention;

FIG. 12 illustrates an example method for analyzing biological data in accordance with an aspect of the present invention;

FIG. 13 illustrates an example application of the model illustrated in FIG. 11;

FIG. 14 shows various features of a computer system for use in conjunction with aspects of the invention; and

FIG. 15 shows an example computer system for use in conjunction with aspects of the invention.

### DETAILED DESCRIPTION

Aspects of the present invention include methods, systems, and devices for providing analytical data, medical diagnosis, prognosis and/or predictive analysis of a tissue sample.

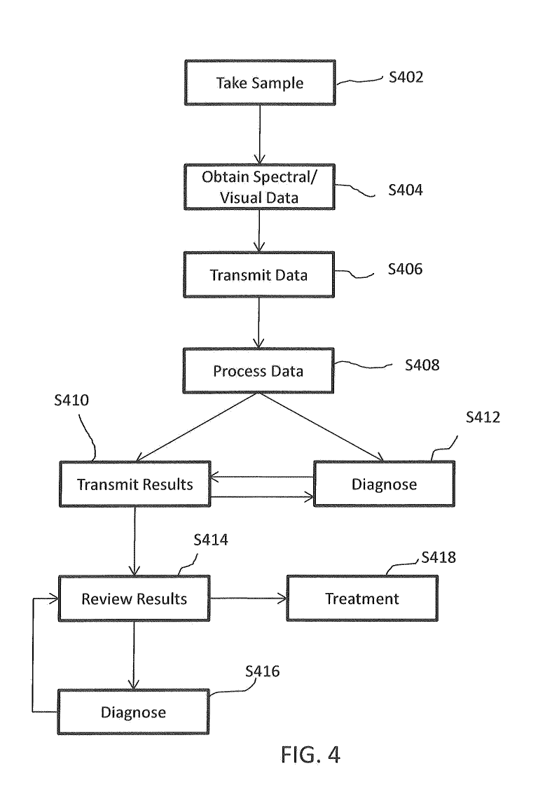

FIG. 4 illustrates an exemplary flowchart of the method for providing analytical data, a medical diagnosis, prognosis and/or predictive analysis to a practitioner, in accordance with aspects of the present invention. In FIG. 4, according to various aspects of the present invention, the method may include taking a biological sample S402. The sample may be taken by a practitioner via any known methods.

The sample may, for example, consist of a microtome section of tissue from biopsies, a deposit of cells from a sample of exfoliated cells, or Fine Needle Aspiration (FNA). However, the disclosure is not limited to these biological samples, but may include any sample for which spatially resolved infrared spectroscopic information may be desired.

A variety of cells or tissues may be examined using the present methodology. Such cells may comprise exfoliated cells, including epithelial cells. Epithelial cells are categorized as squamous epithelial cells (simple or stratified, and keritized, or non-keritized), columnar epithelial cells (simple, stratified, or pseudostratified; and ciliated, or nonciliated), and cuboidal epithelial cells (simple or stratified, ciliated or nonciliated). These epithelial cells line various organs throughout the body such as the intestines, ovaries, male germinal tissue, the respiratory system, cornea, nose, and kidney. Endothelial cells are a type of epithelial cell that can be found lining the throat, stomach, blood vessels, the lymph system, and the tongue. Mesothelial cells are a type of epithelial cell that can be found lining body cavities. Urothelial cells are a type of epithelial cell that are found lining the bladder.

After a sample has been obtained, the method may include obtaining spectral data from the sample S404. In an aspect of the present invention, the spectral data may be obtained by the practitioner through a tunable laser-based infrared imaging system method, which is described in related U.S. patent application Ser. No. 13/084,287. The data may be obtained by using an IR spectrum tunable laser as a coherent transmission source. The wavelength of IR transmissions from the tunable laser may be varied in discrete steps across a spectrum of interest, and the transmitted and/or reflected transmissions across the spectrum may be detected and used in image analysis. The data may also be obtained from a commercial Fourier transform infrared spectroscopy (FTIR) system using a non-laser based light source such as a globar, or other broad band light source.

One example laser in accordance with aspects of the present invention is a QCL, which may allow variation in IR wavelength output between about six and 10 μm, for example. A detector may be used to detect transmitted and/or reflected IR wavelength image information. In operation, with minimal magnification, a beam output from the QCL may suitably illuminate each region of a sample in the range of 10×10 μm for detection by a 30×30 μm detector.

In one example implementation in accordance with aspects of the present invention, the beam of the QCL is optically conditioned to provide illumination of a macroscopic spot (ca. 5-8 mm in diameter) on an infrared reflecting or transmitting slide, on which the infrared beam interacts with the sample. The reflected or transmitted infrared beam is projected, via suitable image optics, to an infrared detector, which samples the complete illuminated area at a pixel size smaller than the diffraction limit.

The infrared spectra of voxels of tissue or cells represent a snapshot of the entire chemical or biochemical composition of the sample voxel. This infrared spectra is the spectral data obtained in S404. While the above description serves as a summary of how and what spectral data is obtained in S404, a more detailed disclosure of the steps involved in obtaining the data is provided in U.S. patent application Ser. No. 13/084,287.

In addition to the spectral data, S404 may include collecting a visual image of the same biological sample. A visual image of the sample may be obtained using a standard visual microscope, such as one commonly used in pathology laboratories. The microscope may be coupled to a high resolution digital camera that captures the field of view of the microscope digitally. This digital real-time image may be based on the standard microscopic view of a sample, and may be indicative of tissue architecture, cell morphology, and staining patterns. The image may be stained, e.g., with hematoxylin and eosin (H&E) and/or other constituents, immunohistochemicals, etc., or unstained.

Furthermore, in addition to the above data, S404 may also include obtaining clinical data. Clinical data may include any information that may be relevant to a diagnosis and/or prognoses including what type of cells are likely present in the sample, what part of the body the sample was taken, and what type of disease or condition is likely present among other diagnoses.

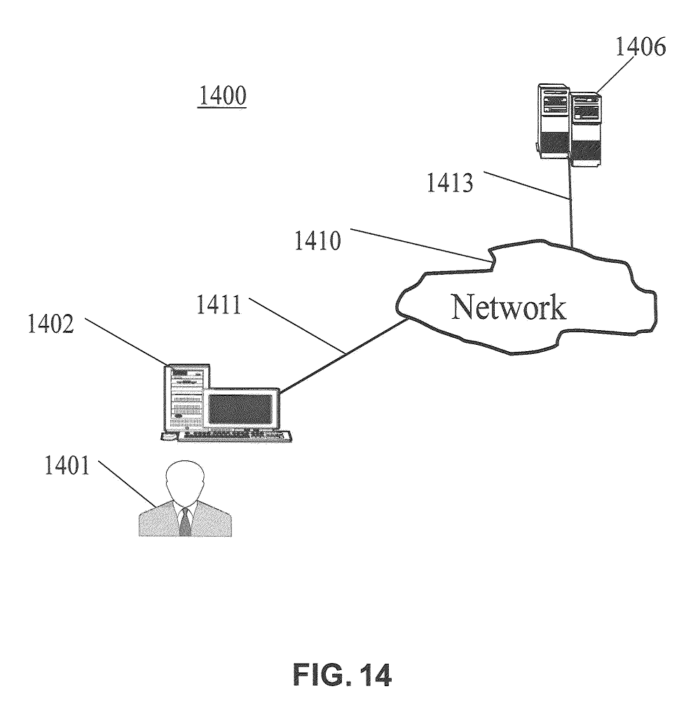

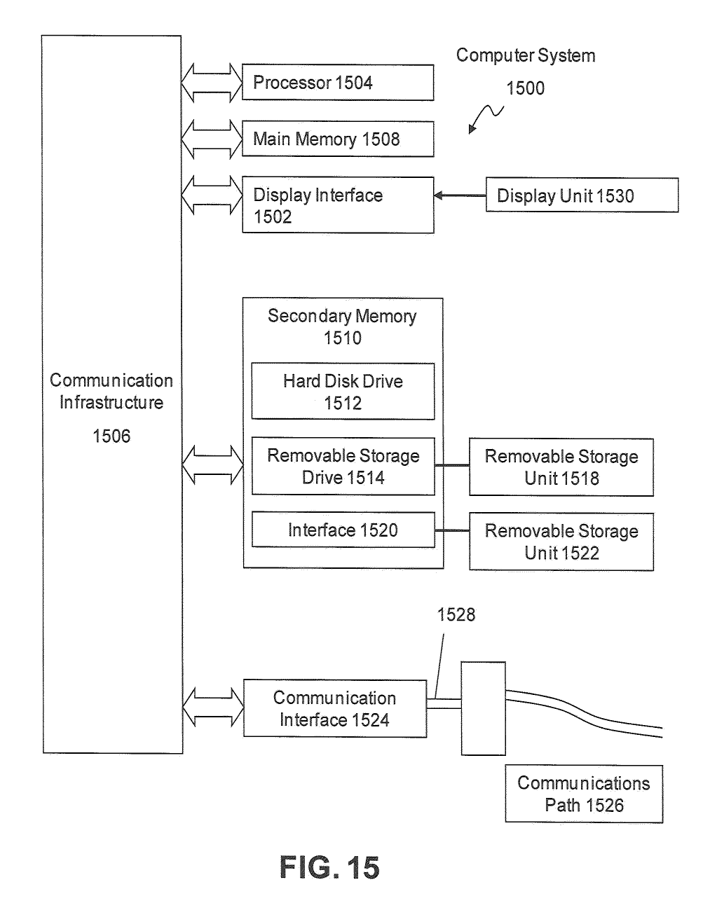

After the total data has been acquired by the practitioner, e.g., the spectral data, the visual image, and clinical data, among other data, the method may include transmitting the data to an analyzer. For example, the analyzer may have a receiving module operable to receive the transmitted data. The data may be automatically or manually entered into an electronic device capable of transmitting data, such as a computer, mobile phone, PDA and the like. In an aspect of the present invention the analyzer may be a computer located at a remote site having appropriate algorithms to analyze the data. In another aspect of the present invention, the analyzer may be a computer located within the same local area network as the electronic device that the data has been entered into or may be on the same electronic device that the data has been entered into (i.e., the practitioner may enter the data directly into the device that analyzes the data). If the analyzer is located remotely from the electronic device, the data may be transferred to the analyzer via any known electronic transferring methods such as to a local computer through a local area network or over the Internet. The network layout and system for communicating the data to the analyzer is described in more detail below with respect to FIGS. 14 and 15.

In another aspect of the present invention, instead of the practitioner obtaining the data on the practitioner end and sending the data to the analyzer at a remote site, the sample itself may be sent to the analyzer. For example, the analyzer may have a receiving module operable to receive the sample. When the physical sample is sent to the analyzer, a practitioner operating the analyzer may instead obtain the spectral data. In this case, the biological sample may be physically delivered to the analyzer at the remote site instead of just spectral data being delivered. However, the practitioner may still provide the clinical data, when applicable.

After all of the desired data is acquired by the analyzer, the method may include performing processing via the analyzer to reconstruct the data into an image or other format, that indicates the presence and/or amounts of particular chemical constituents S408. The detailed disclosure of the steps involved in the processing step to reconstruct the data is provided below and in even more detail in U.S. patent application Ser. No. 13/067,777.

As explained the '777 application, when following the processing steps, an image may be produced, which may be a grayscale or pseudo-grayscale image. The '777 application explains how the processing method provides an image of a biological sample this is based solely or primarily on the chemical information contained in the spectral data collected in S404. The '777 application further explains how the visual image of the sample may be registered with a digitally stained grayscale or pseudo-color spectral image. Image registration is the process of transforming or matching different sets of data into one coordinate system. Image registration spatially involves spatially matching or transforming a first image to align with a second image. When the registration method steps are followed as explained in the '777 application, the resulting data allows a point of interest in the spectral data to correspond to a point in the visual sample. The data allows a practitioner, via, e.g., a computer program, to select a portion of the spectral image, and to view the corresponding area of the visual image. The data allows a practitioner to rely on a spectral image that reflects the highly sensitive biochemical content of a biological sample, when analyzing the biological sample.

Alternatively, the data may be reconstructed into a format that is suitable for analysis via computer algorithms to provide a diagnosis, prognosis and/or predictive analysis, without producing an image. This is described in more detail below.

After completing the processing in S408, the method may include returning the analytical data, image, and/or registered image to the practitioner, optionally via a system accessible to the practitioner S410. For example, the system may be the same device that the practitioner used to originally transmit the data. The data, image, and/or registered image (i.e., sample information) may be transmitted, e.g., electronically via the computer network described below. This may include for example, transmitting the sample information in an email or providing access to the sample information once the practitioner has logged into an account where the sample information has been uploaded. Once the practitioner has obtained the sample information at the system, the practitioner may examine the information to diagnose a disease or condition using computer software, for example.

In another aspect of the invention, instead of or in addition to returning an image and/or registered image to the practitioner, the data is further processed to diagnose a disease or condition (S412). This process may include using algorithms based on training sets before the sample information was analyzed. The training sets may include spectral data that is associated with specific diseases or conditions as well as associated clinical data. The training sets and algorithms may be archived and a computer algorithm may be developed based on the training sets and algorithms available. In an aspect, the algorithms and training sets may be provided by various clinics or laboratories. The '777 application also explains the use of training sets and algorithms to analyze the registered image and obtain a diagnosis. For example, as explained in the '777 application, the registered image may be analyzed via computer algorithms to provide a diagnosis.

Alternatively, as explained above, the data that has been reconstructed without producing an image may be compared with data in the training set or an algorithm to analyze the data and obtain a diagnosis, prognosis and/or predictive analysis. That is, in an aspect of the present invention, the method may skip the steps for forming an image, and may instead proceed directly to analyzing the data via comparison with a training set or an algorithm.

In an aspect of the present invention, the practitioner has the option of using one or more algorithms via the computer system to obtain the diagnosis, prognosis and/or predictive analysis. For example, when the practitioner accesses the computer system containing the registered image, the practitioner may select algorithms based on training data provided by specialized clinics or laboratories. The computer system may have a selecting module that may select the algorithms to use for obtaining a diagnosis, prognosis and/or predictive analysis for the biological sample. The selecting module may receive, for example, user assistance or input parameters to aid in the selection of the algorithms. For example, if the practitioner has submitted a biological sample that is suspected to contain lung cancer cells, and a particular clinic already developed a training set and/or algorithm based on a variety of lung cancer samples, the practitioner may elect to run the biological sample using the clinic's lung cancer training set and/or algorithm. Optionally, the practitioner may elect to run multiple algorithms developed from different training sets, including different algorithms for the same type of disease or condition or different algorithms for different diseases. For example, the computer system may have a generating module operable to generate a diagnosis, prognosis and/or predictive analysis for the biological sample based upon the outcome of the algorithms applied to the biological sample. In yet another aspect of the invention, the entirety of all available algorithms may be run, such as when there is no prior indication as to what type disease may be present in the sample. In one embodiment the practitioner may access and select algorithms at the practitioner's system, while the processing may occur at the remote site.

The processing of S408 may also include additional comparative data analysis. For example, after a sample has been analyzed, the system may store any desired sample information, to which future samples can be compared. The results of any particular sample can be compared against all other sample results that have been stored in this system. In an aspect of the present invention, any desired sample information may be compared only to other samples previously analyzed from a particular practitioner, or to samples from a particular patient, for example. Optionally, the practitioner can be alerted if the sample results are inconsistent with past results, and if so, a notification may be sent along with the results. The comparative analysis may also be performed against samples from other practitioners, and/or other clinics or laboratories, among other samples. Optionally, the comparative analysis processing may occur at the remote site.

The diagnosis, prognosis, predictive analysis and/or other relevant sample information may be provided to the practitioner. For example, the system may include a transmitting module operable to transmit the diagnosis, prognosis, predictive analysis, and/or other relevant sample information for the biological sample to the practitioner. The practitioner may access the diagnosis, prognosis and/or predictive analysis via the practitioner's system. In an aspect of the present invention only the diagnosis, prognosis and/or predictive analysis is sent, preferably including an indication (e.g. a percentage value) of sample disease and/or what part of the sample is diseased, and what type of disease is present. In another aspect of the present invention, an image and/or registered image is provided along with the diagnosis, prognosis and/or predictive analysis information. Additional sample information can include statistical analysis and other data, depending on the various algorithms that were run. As discussed above, the delivery of diagnosis, prognosis and/or predictive analysis information may be carried out via, e.g., the computer system discussed below. The step of transmitting the results to the practitioner may also include alerting the practitioner that the results are available. This may include a text message sent to a cellular phone, an email message, and a phone message, among other ways of alerting the practitioner.

After the practitioner has received the data, and/or alert to access the data, the practitioner may review the results at S414. After the results have been reviewed, it may be determined that additional algorithms should be run against the sample. For example, if the practitioner is unable to determine the diagnosis with certainty, or if the practitioner is not satisfied with the algorithms that were already run, the determination may be made that additional algorithms should be run to provide a more accurate diagnosis. If the determination is made that additional algorithms should be run, the method may include performing additional diagnostic steps S416. In S416, using the computer system, different algorithms may be selected by the practitioner such as algorithms created by other specialized clinics or laboratories for the same disease or condition and/or algorithms for additional diseases or conditions. The updated diagnosis may then be delivered to the practitioner for review. S414 and S416 may be repeated until the practitioner is satisfied with the diagnosis. Once the practitioner is satisfied with the diagnosis, the method may optionally proceed to S418, and the practitioner may proceed to treat the patient based on the information obtained in the method.

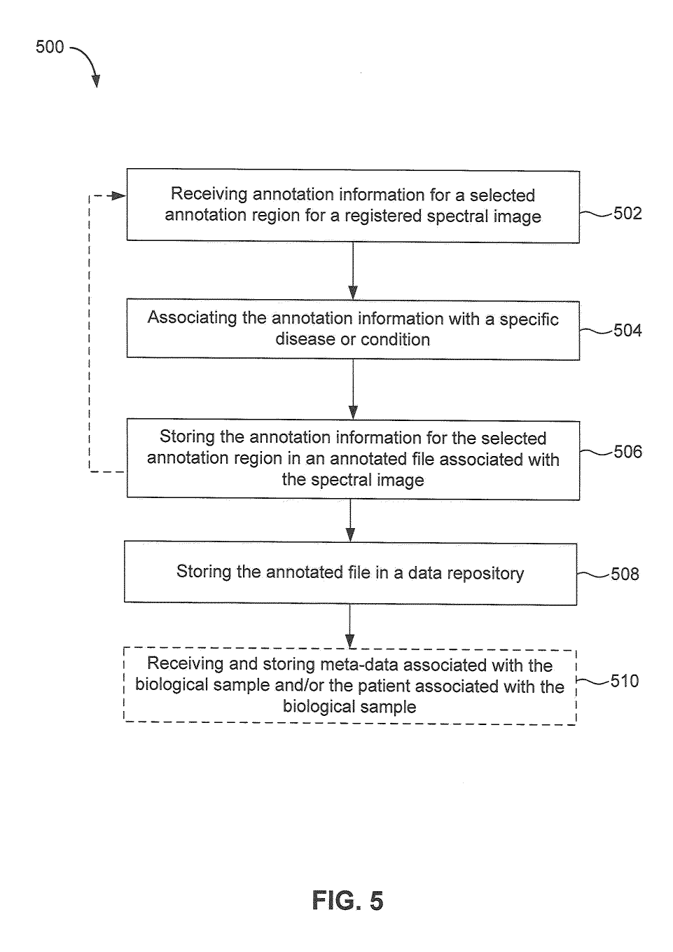

Referring now to FIG. 5, illustrated therein is a method flow 500 for populating a data repository in accordance with an aspect of the present invention. The data from the data repository may be used, for example, for training one or more algorithms to obtain a diagnosis of a biological sample. In addition, the data may be used for data mining purposes, such as identifying particular patterns of biological samples, and/or diseases to aid with predictive and prognostic analysis. The data repository may also be used for storing one or more classification models of diseases that may be used by the system to diagnose a disease found within a biological sample.

The method may include receiving annotation information for a selected annotation region of a registered spectral image 502. Annotation information may include, but is not limited to, any suitable clinical data regarding the selected annotation region, such as data that may be relevant to a diagnosis, including what biochemical signatures as correlated to a feature of a type of cells and/or tissues that are likely present in the sample, staining grades of the sample, intensities, molecular marker status (e.g., molecular marker status of IHC stains), what part of the body the sample was taken, and/or what type of disease or condition is likely present. In addition, the annotation information may relate to any measurable mark on the visual image of the sample. The annotation information may also include, for example, a time stamp (e.g., a date and/or time when the annotation was created), parent file annotation identifier information (e.g., whether the annotation is part of an annotation set), user information (e.g., name of user who created the annotation), cluster information, cluster spectra pixel information, cluster level information, and a number of pixels in the selected region, among other information relating to the annotation. It should be noted that the system may receive the annotation information from a practitioner.

In an aspect, a practitioner may select an annotation region of the registered spectral image and may provide the annotation information for the selected region. The practitioner may use the system to select a region of the registered image that corresponds to a biochemical signature of a disease and/or condition. For example, the practitioner may place a boundary around an area in the spectral image where the spectra of pixels of the spectral image appear to be generally uniform (e.g., the color in the area of the spectral image is mostly the same color). The boundary may identify a plurality of pixels in the spectral image that correspond to a biochemical signature of a disease or condition. In another aspect, the practitioner may select an annotation region based upon one or more attributes or features of the visual image. Thus, the annotation region may correspond to a variety of visual attributes of the biological sample as well as biochemical states of the biological sample. Annotation regions are discussed in more detail in U.S. patent application Ser. No. 13/507,386. It should also be noted that the practitioner may select an annotation region of the registered spectral image that does not correspond to a biochemical signature of a disease or condition.

In another aspect, the system may automatically or otherwise (e.g., with some user assistance or input parameters) provide the annotation information for the selected annotation region. For example, the system may provide the date and time the annotation was created, along with the cluster information for the selected region. In addition, the system may automatically or otherwise select the annotation region of the registered spectral image and provide the clinical data (e.g., data that may be relevant to a diagnosis and/or prognosis and classifications of a diseases or condition) for the selected annotation region.

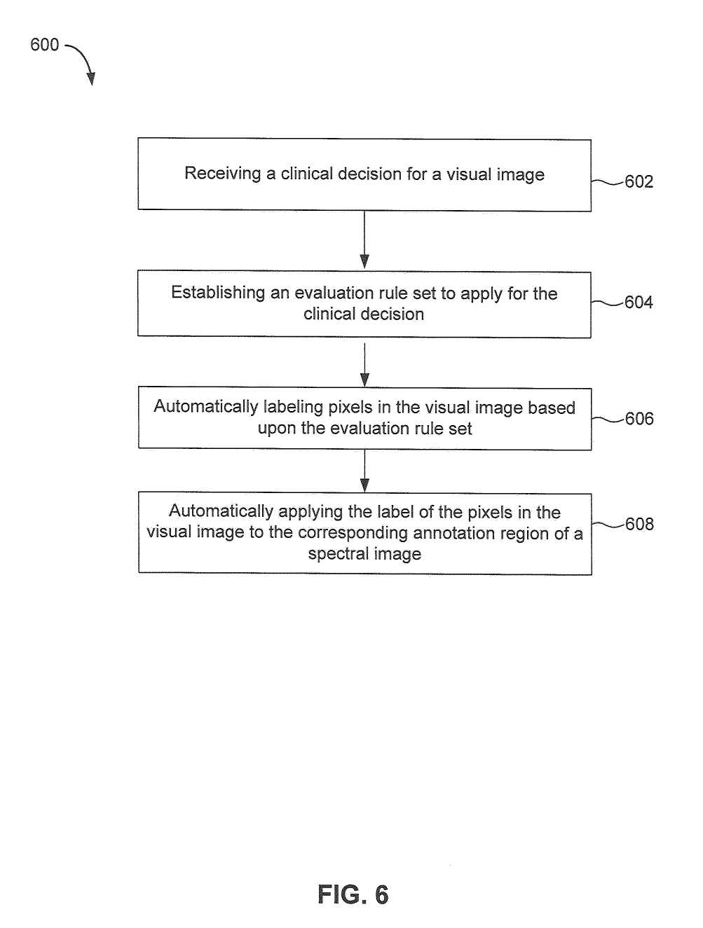

Referring now to FIG. 6, illustrated therein is a method 600 for automatically labeling an annotation region by applying a rule set to a visual image in accordance with an aspect of the present invention. The method may include receiving a clinical decision for a visual image 602. For example, the system may receive a clinical decision, such as a diagnosis from a medical practitioner including what type of cells are likely present in the sample and/or what type of disease or condition is likely present within the sample.

The method may also include establishing an evaluation rule set to apply for the clinical decision 604. In an aspect, the system may select a clinical “gold standard” as the evaluation rule set to apply to the clinical decision. A clinical “gold standard” may include, for example, accepted practices for the current state-of-the-art. For example, clinical “gold standards” may include using stains on biological samples such as, but not limited to, IHC stains and panels, hematoxylin stains, eosin stains, and Papanicolaou stains. In addition, clinical “gold standards” may also include using a microscope to measure and indentify features in a biological sample including staining patterns. The system may scan some or all of the pixels in the visual image and apply the evaluation rule set to the pixels.

In addition, the method may include automatically or otherwise labeling pixels in the visual image based upon the evaluation rule set 606. In an aspect, the system may automatically label each pixel in the visual image based upon the evaluation rule set.

The method may also include automatically applying the label from the pixels in the visual image to the corresponding annotation region of a spectral image 608. In an aspect, the system may retrieve the stored spectral image that is registered with the visual image, for example, from a data repository. The system may determine the label of the visual image that corresponds to the annotation region of the spectral image and may automatically apply the label from the corresponding area of the visual image to the annotation region of the spectral image. It should be noted that any pixel corresponding to a measureable mark on the visual image may be a target for labeling and correlation to a spectral pixel. Thus, one or more quantitative pathology metrics known in a pathology practice may become a class by selecting the corresponding pixels in the visual image and correlating the selected pixels from the visual image to the spectral image for the same spatial location.

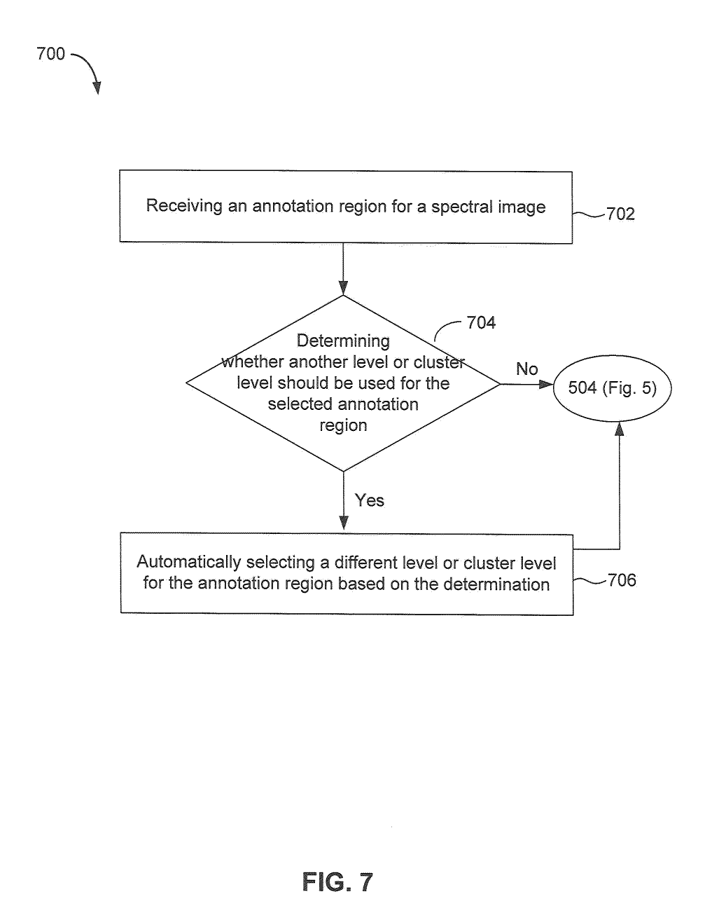

Referring now to FIG. 7, illustrated therein is a method flow 700 for automatically or otherwise selecting another annotation region in accordance with an aspect of the present invention. The method may include receiving an annotation region for a registered spectral image 702. The system may receive one or more annotation regions for the spectral image as discussed above in 502 (FIG. 5).

The method may also include determining whether another level or cluster level should be used for the selected annotation region 704. In an aspect, the system may determine whether another level or cluster level within the spectral image may be a better selection for the selected annotation region. For example, the system may review all the cluster levels of the spectral image and may identify a cluster level where the spectral clusters of pixels are relatively uniform (e.g., a homogeneous spectral cluster of pixels with similar spectra per a predetermined parameter). In an aspect, the system may present each homogeneous spectral cluster as a single color (e.g., blue for one cluster and red for a different cluster). The system may compare the identified cluster level with the cluster level for the selected annotation region of the spectral image, and, if the system determines that a match occurs, the system may determine that another level or cluster level should not be selected for the annotation region. The method may proceed to 504 (FIG. 5) upon determining that another level or cluster level should not be selected for the annotation region.

The method may further include automatically or otherwise selecting a different level or cluster level for the annotation region based on the determination 706. For example, when the system compares the identified cluster level with the cluster level for the selected annotation region and if a match does not occur, the system may determine whether the spectra for the pixels in the identified cluster region are more similar in relation to the predetermined parameter. In an aspect, the system may determine whether the color of the identified region is more uniform in color than the selected region. The system may, for example, automatically select the identified cluster level for the annotation region upon determining that the identified region has more similar spectra per the predetermined parameter than the selected region. In an aspect, the identified cluster level may be more uniform in color than the color for the selected region. By allowing the system to automatically select a cluster level for the selected region, the system may identify a better choice for the annotation region than what the user identified. Upon selecting a different cluster level for the selected region, the method may proceed to 504 (FIG. 5).

Referring back to FIG. 5, the method may also include associating the annotation information with a specific disease or condition 504. In an aspect, the system may associate the clinical data identifying a disease or condition with the received annotation information. For example, the system may associate the disease information with the cluster level and/or the spectra of the cluster level for the selected region.

The method may further include storing the annotation information for the selected annotation region in an annotated file associated with the registered spectral image 506. For example, the system may store the annotation information in a textual file, such as an eXtensible Markup Language (xml) annotation file or a binary formatted file.

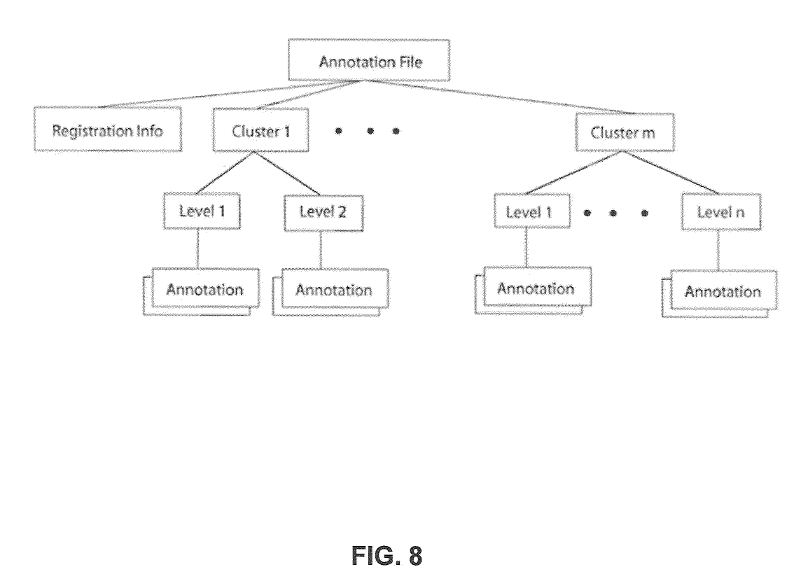

Referring now to FIG. 8, illustrated therein is an example annotated file 800 in accordance with an aspect of the present invention. The annotated file 800 may be stored in a nested format that can store hierarchical tree data. For example, the annotated file 800 may include at the root (e.g., the top of the tree) information about the data set as a whole, such as the spectral image file name that defines the root directory, the physician name, registration information 802, elapsed time, etc. The branches of the tree may include the spectral cluster 804 and level information 806, 808 for the spectral image. For example, each cluster 804 may have a number of levels 806, 808, each of which may include a number of annotations 810, 812. The annotation information associated with each specific cluster, level, and annotation may be stored at the leaf level.

It should be noted that some of the cluster/level branches in the annotated file 800 may not have any annotations associate with the respective cluster/level. Thus, such annotation branches may be empty and/or non-existent.

Referring back to FIG. 5, the method may optionally proceed to 502 and receive additional annotation information for the same selected region of the registered image and/or for a different region of the registered image.

The method may further include storing the annotated file in a data repository 508. It should be noted that the data repository may store a plurality of annotated files.

The method may optionally include receiving and storing meta-data associated with the biological sample and/or the patient associated with the biological sample 510. Meta-data may include, but is not limited to, age of the patient, sex of the patient, treatment sequence, tumor status (e.g., stage of the tumor), lymph node status (e.g., + or −), metastasis status, tumor grade, tumor location, immuno-histochemical (IHC) markers (e.g., + or −), molecular markers (e.g., + or −), survival (e.g., a percentage of survival over a period of time), clinical history, surgical history, differential Dx, and pathology annotation, among other meta-data. For example, the system may receive the meta-data from a practitioner. It should be noted that the meta-data may be provided by the practitioner along with the annotation information. In another aspect, the system may import the meta-data from one or more files associated with the biological sample and/or the patient (e.g., a medical history file for the patient). For example, the system may access the meta-data from an Electronic Medical Record (EMR) linked to a patient, for example, through a patient identifier (ID) and/or a patient-sample identifier.

In addition, the meta-data may be associated with the annotation file stored for the biological sample. Thus, the meta-data may be associated with the pixels of the spectral images and/or the visual images stored in the data repository.

In an aspect, the meta-data may be used by the system to mine the data in the data repository for one or more correlations and/or direct relationships among the data stored. One example of data mining may include the system determining the correlation among the clinical history by patient and by disease class for all patients. Another example may include the system performing literature data mining using classification fields/labels in the dataset to externally mine literature databases and report citations in summary for clinician reference. The system may also be used, for example, to mine the data for correlations and variance analysis to determine best practices. In addition, the system may be used to mine the data for experimental results and developments within an institution's drug development research program database. For example, the system may receive an inquiry from a user of the system for a particular correlation and/or relationship for a particular disease. The system may mine some or all of the data stored and generate a correlation and/or relationship based upon the meta-data associated with the particular disease.

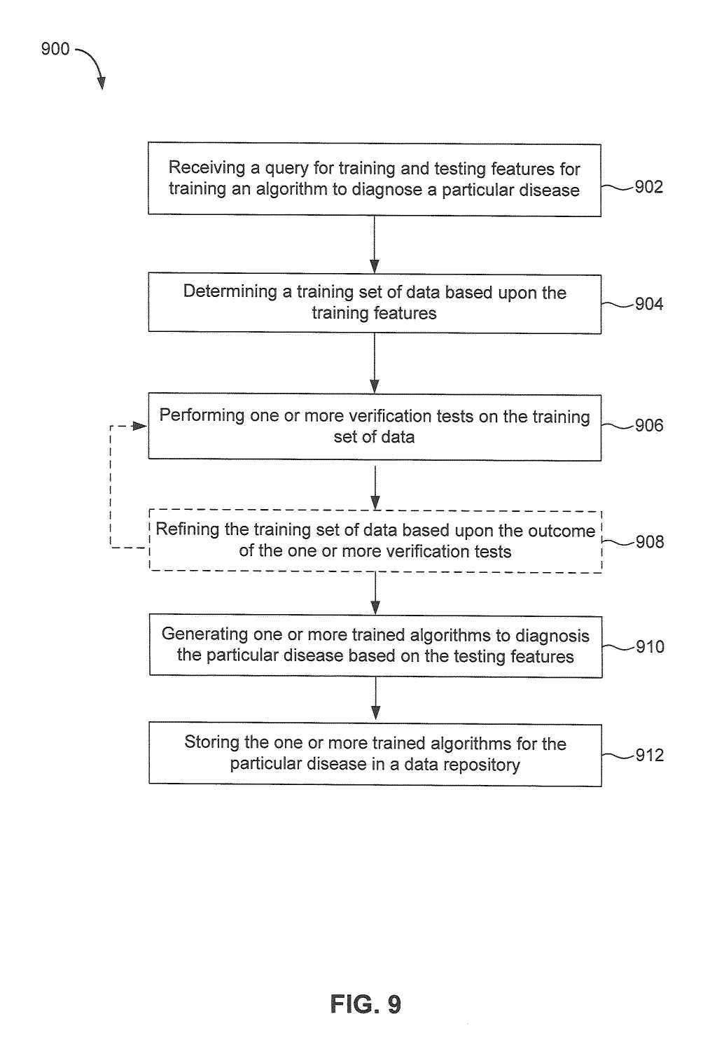

Referring now to FIG. 9, illustrated therein is an example method flow 900 for training algorithms to provide a diagnosis, prognosis and/or predictive classification of a disease or condition in accordance with an aspect of the present invention.

The method may include receiving a query for training and testing features for training an algorithm to diagnose and/or predict a particular disease or condition 902. For example, the system may receive a query with one or more parameters for training and testing features that may be correlated to a biological signature representative of the particular disease, condition, feature state and/or class. The parameters may include, but are not limited to, a disease or condition type (e.g., lung cancer or kidney cancer), cell or tissue class, tissue type, disease state, classification level, spectral class, and tissue location, among other parameters. In an aspect, the system may receive the query and the parameters from a user of the system. In another aspect, the system may automatically or otherwise determine the parameters that should be used for the particular disease or condition. Thus, the training and testing features may be customized based upon the parameters received.

The method may also include determining a training set of data based upon the training features 904. The system may extract pixels from the visual and spectral images stored in a data repository that correspond to the parameters for the training testing features. For example, the system may access the annotated images stored in the data repository, along with any suitable annotation information and/or meta-data corresponding to the annotated images. The system may compare the parameters of the query with the annotation information and/or meta-data of the annotated images. Upon a match occurring between the parameters and the annotation information and/or the meta-data, for example, the system may extract the pixels of the visual and spectral images associated with the parameters and form a training set of data. The pixels extracted for the training data may include pixels from different cells or tissues classes and/or tissue types. It should be noted that the pixels extracted from different tissue types may be stored as part of different testing features. Thus, for example, pixels from the same tissue type may be assigned to a single testing feature, while pixels from a different tissue type may be assigned to a different testing feature. In addition, the training data may include spectral data that is associated with specific diseases or conditions or cell or tissue types (collectively, a “class”). Thus, the system may extract pixels of the visual and spectral images that may provide a meaningful representation of the disease or condition based upon the parameters provided for the training features to provide a diagnosis, a prognosis and/or predictive analysis of the disease or condition.

In addition, the method may include performing one or more verification tests on the training set of data 906. Verification tests may include, but are not limited to, quality tests and feature selection tests on the training set of data. In an aspect, the system may utilize the algorithm created by the training set of data in conjunction with a testing set of data to verify the accuracy of the algorithm. The testing set of data may include biological samples that contain the particular disease or condition, along with biological samples that do not contain the particular disease or condition. The system may verify the accuracy of the algorithm, for example, by determining whether the algorithm can correctly identify biological samples that contain the particular disease or condition and biological samples that do not contain the particular disease or condition. When the algorithm can correctly identify which biological samples contain the disease or condition and which biological samples do not contain the disease or condition, the system may determine that the accuracy of the algorithm is high. However, when the algorithm is not able to correctly identify which biological samples from the testing data contain the disease or condition or incorrectly identifies biological samples as containing the disease or condition, the system may determine that the accuracy of the algorithm is low. In an aspect, the results of the algorithm may be compared against an index value that may indicate the probability of whether the algorithm correctly identified the biological samples. Index values above a threshold level may indicate a high probability that the algorithm correctly identified the biological samples. While index values below a threshold level may indicate a low probability that the algorithm correctly identified the biological samples.

The method may optionally include refining the training set of data based upon the outcome of the one or more verification tests 908. For example, upon the system determining that the accuracy of the algorithm is low, the system may refine the training set of data. The system may increase and/or decrease the number of pixels in order to increase the likelihood of statistically relevant performance of the algorithm. It should be noted that the number of pixels that are required for the training set of data may vary based upon the type of disease or condition the algorithm is trying to diagnose and/or the cell or tissue class selected, for example. The method may continue to 906 until the system determines that the accuracy of the algorithm is high in relation to the testing set of data.

The method may further include generating one or more trained algorithms to provide a diagnosis, a prognosis and/or predictive analysis for the particular disease, based on the testing features 910. Upon the system determining that the algorithm has a high accuracy, the system may generate one or more trained algorithms to provide a diagnosis, a prognosis and/or predictive analysis for the particular disease based upon the testing features. It should be noted that a plurality of algorithms may be generated to provide a diagnosis, a prognosis and/or predictive analysis for a disease, based upon the received parameters. For example, multiple algorithms may be trained to diagnose lung cancer with each algorithm trained to diagnose a particular type of lung cancer, based upon different parameters that may be correlated and coupled to a biochemical signature representative of the disease or feature state and class of the disease.

The method may also include storing the one or more trained algorithms for the particular disease in a data repository 912. For example, the system may store the one or more trained algorithms in a data repository that also contains the annotated spectral and visual images, annotation information and/or meta-data, as discussed above in conjunction with FIGS. 5-8.

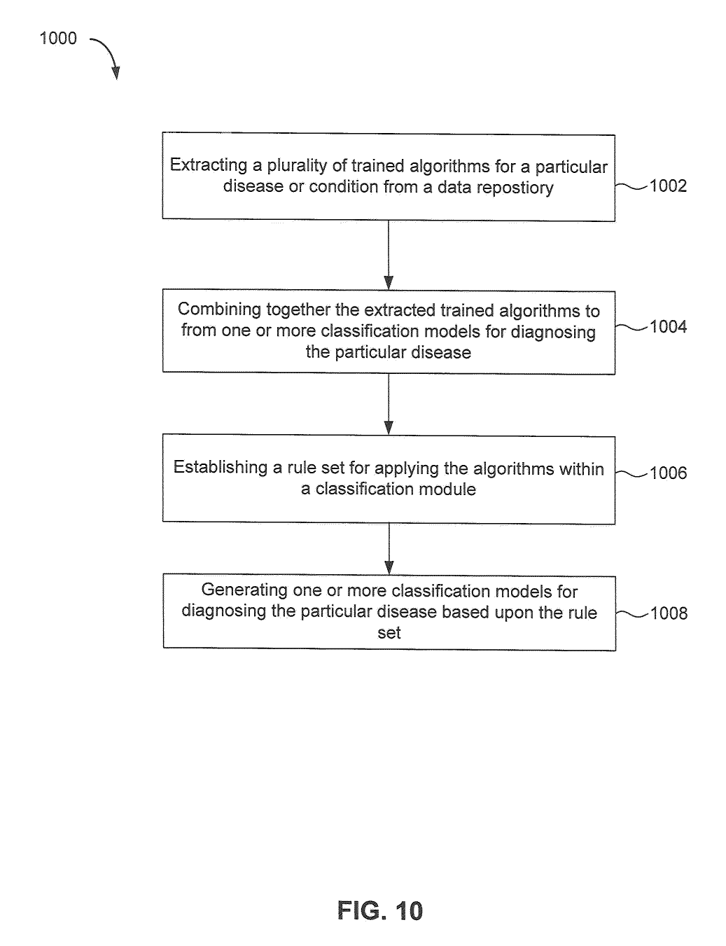

Referring now to FIG. 10, illustrated therein is an example method flow 1000 for creating a classification model in accordance with an aspect of the present invention. The method may include extracting a plurality of trained algorithms for a particular disease or condition from a data repository 1002. In an aspect, the system may receive a request from a user of the system to extract the plurality of algorithms relating to the particular disease or condition.

The method may also include combining together the extracted trained algorithms to form one or more classification models for diagnosing the particular disease 1004. For example, the system may combine various algorithms for diagnosing different forms of cancer (e.g., lung cancer, breast cancer, kidney cancer, etc.) to form one model for diagnosing cancer. It should be noted that the classification models may also include sub-models. Thus, the classification model for diagnosing cancer may have sub-models for diagnosing various forms of cancer (e.g., lung cancer, breast cancer, kidney cancer). Moreover, the sub-models may further include sub-models. As an example, the model for diagnosing lung cancer may have multiple sub-models for identifying the type of lung cancer that may be present in the biological sample.

In addition, the method may include establishing a rule set for applying the algorithms within a classification model 1006. For example, the system may establish a rule set for determining an order for applying the algorithms within the classification model. In addition, the system may establish a rule set for placing constraints on when the algorithms may be used. It should be noted that the rule set may vary based upon the diseases and/or the number of algorithms combined together to form the models.

The method may further include generating one or more classification models for diagnosing the particular disease, based upon the rule set 1008. Upon the system establishing a rule set for the models, the system may generate one or more models for diagnosing the particular disease. It should be noted that in addition to the above method, a variety of other methods may be used for creating a classification model for a particular disease or condition.

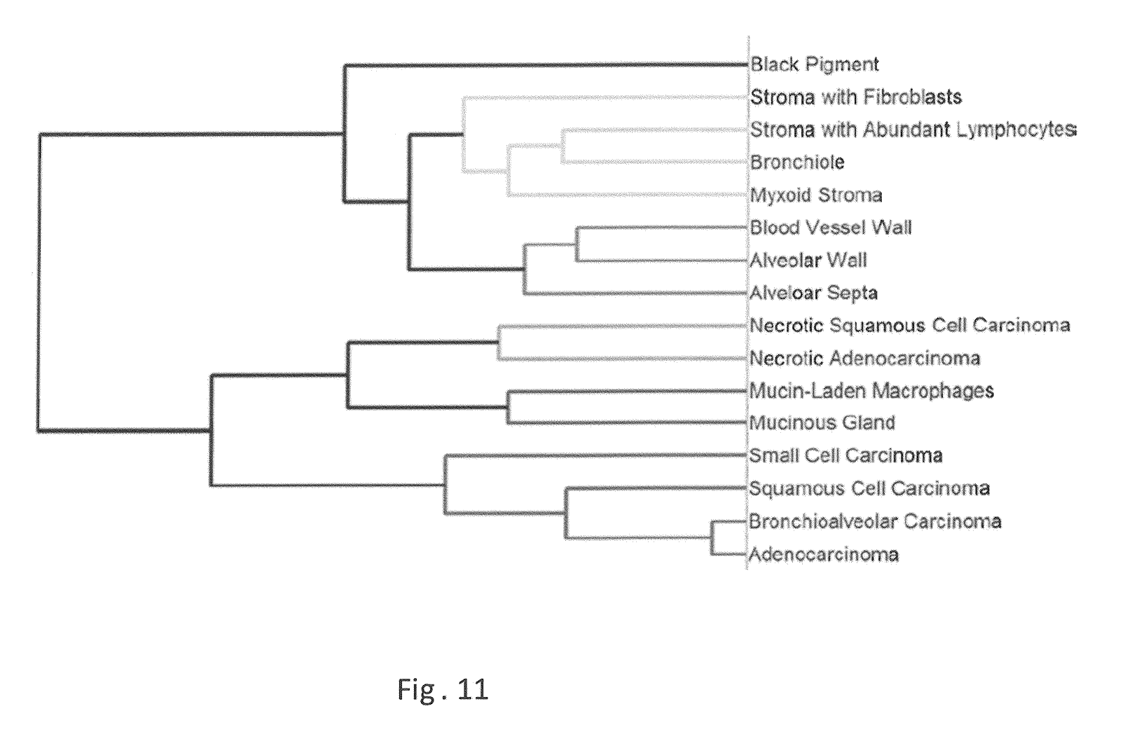

Referring now to FIG. 11, illustrated is an example model for diagnosing lung cancer in accordance with an aspect of the present invention. Each bracket split represents a new iteration. FIG. 11 includes a variety of tissue or cellular classes that may tested for using the inventive analytical method. In an example aspect of the present invention, the data repository used in the analytical method may include all of the tissue or cellular classes listed. Classes may be derived from and may be listed, for example, to reflect expert opinions, group decisions, and individual and institutional standards. Thus, the algorithms used to provide a diagnosis, and/or a prognosis or predictive analysis for a biological sample may be trained to implement expert practices and standards which may vary from institution to institution and among individuals. In operation, when a practitioner desires to know whether a sample contains one of the tissue or cellular classes listed, the method described above may be applied according to FIG. 11. That is, starting from the leftmost bracket, the iterative process is repeated, as illustrated, until the desired result is reached. It should be noted that the particular order of iterations, shown in FIG. 11, achieves a surprisingly accurate result.

The order of iterations as illustrated in FIG. 11, alternatively referred herein as variation reduction order, may be determined using hierarchical cluster analysis (HCA). HCA is described in detail in U.S. patent application Ser. No. 13/067,777. As described in the '777 application, HCA identifies cellular and tissue classes that group together due to various similarities. Based on the HCA, the most effective order of the iterations, or variation reduction order, may be determined. That is, the iteration hierarchy/variation reduction order may be established based on the least to greatest variation in data, which is provided by HCA. By using HCA, based on the similarity or variance in the data, it can be determined which class of tissue or cell should be labeled and not included in the subsequent data subset to remove variance and improve the accuracy of the identification.

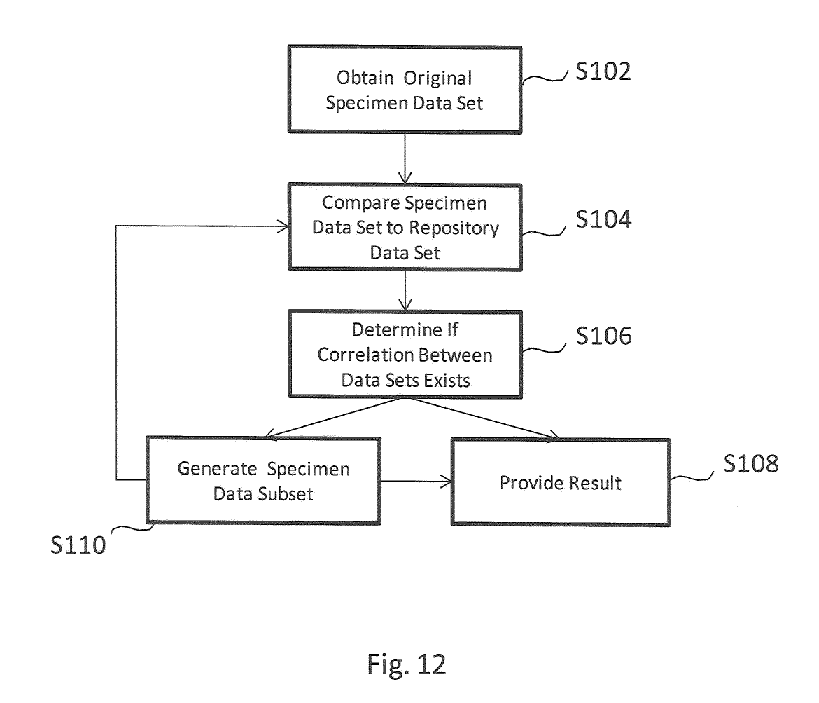

Referring now to FIG. 12, illustrated therein is an example method for analyzing data, in accordance with aspects of the present invention. The method may include obtaining an original set of specimen data from a biological sample S102.

The biological sample may be taken by a practitioner via any known methods and a variety of cells or tissues may be examined using the present methodology, both of which are described in more detail above and in U.S. patent application Ser. No. 13/067,777.

Obtaining the original specimen data set includes obtaining spectroscopic data from the sample. The term “original” means the totality of data obtained before any of the data has been labeled and before a data subset has been generated, which is described in detail below. The term spectroscopic data encompasses any suitable data that is based on spectral data. That is, the spectroscopic data of the original specimen data set obtained in S102 may include reconstructed spectral data, reconstructed image data, and/or registered image data. Furthermore, spectroscopic data may include data that is derived from spectroscopic data, such as statistical values representative of the spectroscopic data. In an aspect of the present invention, the spectral data may be obtained by the practitioner through a tunable laser-based infrared imaging system method, which is described in related U.S. patent application Ser. No. 13/084,287 and the '777 application. An example of how to obtain reconstructed spectral data, reconstructed image data and registered image data is described in more detail in the '777 application. An example of the manner in which the data is obtained by an analyzer is discussed in more detail above.

As discussed above, the specimen data is further processed to provide a diagnosis, a prognosis and/or predictive analysis for a disease or condition by an analyzer. For example, as explained in the '777 application, the registered image may be analyzed via computer algorithms to provide a diagnosis. It should be noted that the registered image may also be analyzed via computer algorithms to provide a prognosis and/or predictive classification of a disease or condition. This process includes using a training set that has been utilized to develop an algorithm. The training set includes spectral data that is associated with specific diseases or conditions or cell or tissue types (collectively, a “class”). As discussed above, the training set may be archived, and a computer algorithm may be developed based on the training sets available. In addition, the '777 application further explains the use of training sets and algorithms to analyze the registered image and obtain a diagnosis.

While the '777 application generally describes how various algorithms may be used to diagnose a condition, the present invention is directed to an improved manner of applying the algorithms to increase the accuracy of the result. Furthermore, the methods described above and in the '777 application allow the sample to be analyzed via trained algorithms for any condition based on the practitioner's choosing. For example, the practitioner may choose to test a sample generally for cancerous cells or for a particular type of cancer. The conditions that are tested may be based on clinical data (e.g., what condition is most likely present) or by “blindly” testing against various conditions. The method disclosed herein increases the accuracy of the diagnosis, and in particular, increases the accuracy, even when there is little or no information regarding which conditions are likely present. Moreover, the method disclosed herein may be used for prognosis and/or predictive classifications of a disease or condition.

After obtaining the original specimen data set in S102, including spectroscopic data, the method may include comparing the original sample data set with repository data S104. The repository data comprises data that is associated with at least one tissue or cellular class. In an aspect of the present invention, the repository data comprises data associated with some or all known tissue or cellular classes. For example, the repository data may comprise data that is associated with a cancer tissue or cellular class, data that is associated with a non-necrotic tissue or cellular class, data that is associated with a non-small cell carcinoma tissue or cellular class, data that is associated with a non-squamous cell carcinoma tissue or cellular class, data that is associated with a bronchioalveolar carcinoma tissue or cellular class, and data that is associated with an adenocarcinoma tissue or cellular class. The repository data may also comprise data associated with or known to not be associated with any one or any combination of the following types of tissue or cellular classes: black pigment, stroma with fibroblasts, stroma with abundant lymphocytes, bronchiole, myxoid stroma, blood vessel wall, alveolar wall, alveolar septa, necrotic squamous cell carcinoma, necrotic adenocarcinoma, mucin-laden microphages, mucinous gland, small cell carcinoma, squamous cell carcinoma, bronchioalveolar carcinoma, and adenocarcinoma (FIG. 11). Each tissue or cellular class has spectroscopic features that are indicative of that tissue or cellular class. That is, a given tissue or cellular class has unique spectroscopic features. Because of this unique spectroscopic quality, it is possible to compare the specimen data to the repository data, and in particular, compare specimen data to a subset of the repository data that is associated with a particular tissue or cellular class. It should be noted that FIG. 11 illustrates one representative example of a class and that a variety of other classes reflecting expert opinions and/or new learning in the field may vary. The comparative step is further described in the '777 application.

Having compared the data, the method may include determining whether a correlation exists between the original specimen data set and the repository data set, preferably using a trained algorithm to recognize whether a cellular class is present in the sample S106, as further described in the '777 application.

If the determination is made in S106 that a correlation does not exist between the original specimen data set and the repository data for a specific feature being queried, then the method may include providing or outputting a result of the analysis S108. For example, if it is determined that the original sample data, when compared against a repository comprising, among other data, data associated with cancerous cells, does not exhibit a correlation, then the method may provide or output that the specimen data set does not include a correlation with the class the specimen data was compared against.

If the determination is made in S106 that a correlation does exist between the original specimen data set and the repository data for the feature being queried, then the method may include generating a specimen data subset S110. The specimen data subset may be generated by labeling data from the original specimen data set that is not associated with the repository data for that feature, and then producing a data subset that only comprises the non-labeled data. For example, if it is determined that a correlation exists between the original data set and a repository comprising, among other data, data associated with cancerous cells, then the data that did not correlate to cancerous cells (i.e., data that is not associated with cancerous cell data) may be partially or entirely omitted from further analysis. The data may be omitted by first labeling the portion of the specimen data that has been designated as not correlating with the cancerous cells, and then generating a data subset that only comprises the non-labeled data. Therefore, this newly formed specimen data subset may only contain data associated with the repository data for the feature being queried. In the cancer example, therefore, the specimen data subset may only contain data associated with cancer, because the data not associated with cancer has been omitted from further analysis.

After generating the data subset, the method may either proceed to S108 to provide a result of the analysis or may return to S104 to compare the specimen data subset with further repository data for another feature to be queried, either using the same algorithm or a different algorithm. For example, an initial algorithm may be utilized to distinguish between cancerous and non-cancerous cells, and thereafter a more specialized algorithm may be utilized to distinguish between types of cancer or subtypes of cancer. The method may proceed to S108 to provide a result of the analysis when the result provided is satisfactory, based on the desired level of detail. For example, if a practitioner only desires to know whether the specimen sample contains cancerous cells, and does not wish to know additional details, the method may proceed to report the result of such analysis at S108. However, when additional analysis is desirable, the method may proceed back to step S104 and repeat steps S104-S110. In particular, when the method returns to step S104, the specimen data subset may be compared to a repository data subset associated with a different tissue or cellular class. This step may involve use of the original repository data or different repository data. It is then determined whether a correlation exists (S106), and the results are either reported or a new specimen data subset is generated, along the lines as described above. This iterative process provides a more accurate result because each iteration removes data unrelated to the feature being queried, thereby narrowing the data being analyzed. For example, if the practitioner seeks to determine whether the specimen sample contains a particular type of carcinoma, such as squamous cell carcinoma, the method may initially run through steps S104-S110 establish the relevant data set and remove non-cancerous data. Steps S104-S110 may be repeated to further determine whether there is small cell carcinoma by comparing the specimen data subset with repository data associated with small cell carcinoma and removing non-small cell carcinoma data. Steps S104-S110 may be repeated a second time to determine whether there is squamous cell carcinoma, by comparing the narrow specimen data subset with repository data associated with squamous cell carcinoma. Because the practitioner sought to determine whether there was squamous cell carcinoma, the method may stop and proceed to step S108 to report that there is or is not squamous cell carcinoma present in the sample.

It is within the scope hereof that the aspects of the present invention may be applied to any particular cell or tissue class, whether cancerous or non-cancerous. When the iterative process is applied, the most accurate results may be achieved when the first iteration analyzes the original specimen data set for the broadest cell or tissue class and, with each subsequent iteration, analyzes the resulting specimen data subset for a narrower cell or tissue class. It is also within the scope hereof that the result of any given iteration may be provided or outputted to indicate which portion of the data is associated with a particular condition. For example, if the first iteration is cancer analysis, the method may proceed to a second iteration of the cancerous data, but may also provide or output information regarding the portion of the data that was found to be non-cancerous.

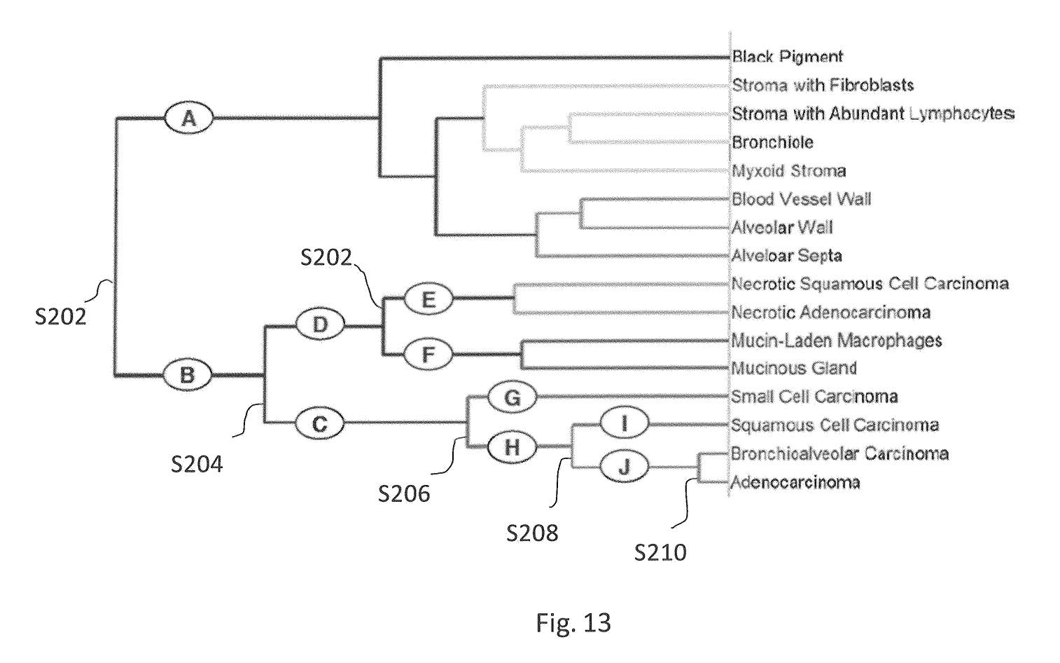

Referring now to FIG. 13, illustrated is an example implementation of FIG. 11 as determined by a set of rules applied to the model illustrated in FIG. 11. As described above, HCA is used to prepare the chart shown in FIG. 13, which is an illustrative example of a variation reduction order. In each of the iterations shown in FIG. 13, the type of cell or tissue class enclosed in a bracket is the type of cell or tissue class that is being analyzed in the iteration. As shown in FIG. 13, the first iteration S302 determines whether the original specimen data set comprises data associated with cancerous type cells or tissue. The method may first proceed through steps S104-S110 discussed above, where the original specimen data set is compared to repository data that is associated with cancerous cells or tissue. At step S110, a specimen data subset may be generated by removing data “A” of FIG. 13 that is not associated with cancerous cells or tissue.

After step S110, the method may proceed to repeat steps S104-S110 with the second iteration S304, which follows the “B” path of FIG. 13. As shown in FIG. 13, the second iteration determines whether the specimen data subset comprises data associated with non-necrotic type cells or tissue. During the second iteration, the specimen data subset may be compared against repository data associated with non-necrotic cells, which may be contained in the same repository, or a different data repository from the repository used for the first iteration. At step S110, a second specimen data subset may be generated by removing data “D” of FIG. 13 that is not associated with non-necrotic cells or tissues.

Notably, the non-necrotic comparison could conceivably be performed at any step in the iterative process, because it is not associated with a particular cell or tissue type. That is, any cell or tissue type may become necrotic. However, it has been surprisingly found that if the necrotic analysis is performed as the second iterative step, the resulting accuracy of the end result is significantly higher than if there is no necrotic iteration or if the necrotic iteration is performed at a later point. That is, by removing the necrotic cancerous data from the cancer data subset, the accuracy of the overall result is significantly increased.

After step S110, the method may proceed to repeat steps S104-S110 with the third iteration S306, which follows the “C” path of FIG. 13. As shown in FIG. 13, the third iteration determines whether the second specimen data subset comprises data associated with non-small cell carcinoma type cells or tissue. During the third iteration, the second specimen data subset is compared against repository data associated with non-small cell carcinoma, which may be contained in the same repository or a different data repository from the repository used for the first or second iteration. At step S110, a third specimen data subset may be generated by removing the data that is not associated with non-small cell carcinoma cells or tissues.

After step S110, the method may proceed to repeat steps S104-S110 with the fourth iteration S308, which follows the “H” path of FIG. 13. As shown in FIG. 13, the fourth iteration determines whether the third specimen data subset comprises data associated with non-squamous cell carcinoma type cells or tissue. During the fourth iteration, the third specimen data subset is compared against repository data associated with non-squamous cell carcinoma, which may be contained in the same repository or a different repository from the repository used in any previous iteration. At step S110, a fourth specimen data subset may be generated by removing the data “I” of FIG. 13 that is not associated with non-squamous cell carcinoma cells or tissues.

After step S110, the method may proceed to repeat steps S104-S110 with the fifth iteration S310, which follow path “J” of FIG. 13. As shown in FIG. 13, the fifth iteration determines whether the fourth specimen data subset comprises data associated with bronchioalveolar carcinoma or adenocarcinoma type cells or tissue analysis. During the fifth iteration, the fourth specimen data subset is compared against repository data associated with bronchioalveolar carcinoma or adenocarcinoma, which may be contained in the same repository or a different data repository from a repository used in any previous iteration. Because the fifth iteration is the final iteration in the example, there is no further need to generate an additional specimen data subset. Instead the final result may be provided or outputted.

It is within the scope hereof that the result of any given iteration may be provided or outputted to indicate which portion of the data is associated with a particular condition. For example, after the first iteration, the method may provide or output information regarding the portion of the data that was found to be non-cancerous. Similarly, after the second iteration, the method may provide or output information regarding the portion of the cancerous data that was found to be necrotic. The same may be repeated for all subsequent iterations.

Additionally, any branching path of FIG. 13 may be followed instead of or in addition to the “B” to “C” to “H” to “J” path described above. For example, after step S302, instead of only analyzing the data subset comprising data associated with cancerous cells (e.g., the “B” path), the method may proceed to perform the analysis on the data associated with non-cancerous cells (i.e., the “A”) path. Similarly, after steps S304, S306, and S308, the method may proceed to perform analysis of the removed sample data (e.g., following the “D”, “E”, “F”, “G”, and “I” paths). The analysis path may be chosen by the end user (e.g. an analyst or other medical professional) based on a particular feature to be queried.

The inventive method, including the example steps of FIG. 13, may be particularly advantageous when there is little preliminary guidance as to what biochemical signatures as correlated to a feature of a cell type and/or tissue that may be present in the sample. Performing the iterations in the order shown in FIG. 13 efficiency reduces the sample data size to a narrow result, while providing critical information after each iteration. When a practitioner is unaware of the sample contents, the analysis may provide accurate results of the biochemical signatures as correlated to a feature of cell types and/or tissues that may be present in the sample. Thus, the method provides an improved and efficient manner of analyzing a sample to provide a diagnosis, prognosis and/or predictive analysis.

FIG. 14 shows various features of an example computer system 1400 for use in conjunction with methods in accordance with aspects of invention. As shown in FIG. 14, the computer system 1400 is used by a requestor/practitioner 1401 or a representative of the requestor/practitioner 1401 via a terminal 1402, such as a personal computer (PC), minicomputer, mainframe computer, microcomputer, telephone device, personal digital assistant (PDA), or other device having a processor and input capability. The server model comprises, for example, a PC, minicomputer, mainframe computer, microcomputer, or other device having a processor and a repository for data or that is capable of accessing a repository of data. The server model 1406 may be associated, for example, with an accessibly repository of disease-based data such as training sets and/or algorithms for use in diagnosis, prognosis and/or predictive analysis.

Any of the above-described data may be transmitted between the practitioner and analyzer, for example, via a network, 1410, such as the Internet, for example, and is transmitted between the analyst 1401 and the server model 1406. Communications are made, for example, via couplings 1411, 1413, such as wired, wireless, or fiberoptic links.

Aspects of the invention may be implemented using hardware, software or a combination thereof and may be implemented in one or more computer systems or other processing systems. In one variation, aspects of the invention are directed toward one or more computer systems capable of carrying out the functionality described herein. An example of such a computer system 1500 is shown in FIG. 15.

Computer system 1500 includes one or more processors, such as processor 1504. The processor 1504 is connected to a communication infrastructure 1506 (e.g., a communications bus, cross-over bar, or network). Various software aspects are described in terms of this exemplary computer system. After reading this description, it will become apparent to a person skilled in the relevant art(s) how to implement the aspects of invention using other computer systems and/or architectures.

Computer system 1500 can include a display interface 1502 that forwards graphics, text, and other data from the communication infrastructure 1506 (or from a frame buffer not shown) for display on the display unit 1530. Computer system 1500 also includes a main memory 1508, preferably random access memory (RAM), and may also include a secondary memory 1510. The secondary memory 1510 may include, for example, a hard disk drive 1512 and/or a removable storage drive 1514, representing a floppy disk drive, a magnetic tape drive, an optical disk drive, etc. The removable storage drive 1514 reads from and/or writes to a removable storage unit 1518 in a well-known manner. Removable storage unit 1518, represents a floppy disk, magnetic tape, optical disk, etc., which is read by and written to removable storage drive 1514. As will be appreciated, the removable storage unit 1518 includes a computer usable storage medium having stored therein computer software and/or data.

In alternative variations, secondary memory 1510 may include other similar devices for allowing computer programs or other instructions to be loaded into computer system 1500. Such devices may include, for example, a removable storage unit 1522 and an interface 1520. Examples of such may include a program cartridge and cartridge interface (such as that found in video game devices), a removable memory chip (such as an erasable programmable read only memory (EPROM), or programmable read only memory (PROM)) and associated socket, and other removable storage units 1522 and interfaces 1520, which allow software and data to be transferred from the removable storage unit 1522 to computer system 1500.

Computer system 1500 may also include a communications interface 1524. Communications interface 1524 allows software and data to be transferred between computer system 1500 and external devices. Examples of communications interface 1524 may include a modem, a network interface (such as an Ethernet card), a communications port, a Personal Computer Memory Card International Association (PCMCIA) slot and card, etc. Software and data transferred via communications interface 1524 are in the form of signals 1528, which may be electronic, electromagnetic, optical or other signals capable of being received by communications interface 1524. These signals 1528 are provided to communications interface 1524 via a communications path (e.g., channel) 1526. This path 1526 carries signals 1528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 1514, a hard disk installed in hard disk drive 1512, and signals 1528. These computer program products provide software to the computer system 1500. Aspects of the invention are directed to such computer program products.

Computer programs (also referred to as computer control logic) are stored in main memory 1508 and/or secondary memory 1510. Computer programs may also be received via communications interface 1524. Such computer programs, when executed, enable the computer system 1500 to perform the features in accordance with aspects of the invention, as discussed herein. In particular, the computer programs, when executed, enable the processor 1504 to perform such features. Accordingly, such computer programs represent controllers of the computer system 1500.

In a variation where aspects of the invention are implemented using software, the software may be stored in a computer program product and loaded into computer system 1500 using removable storage drive 1514, hard drive 1512, or communications interface 1524. The control logic (software), when executed by the processor 1504, causes the processor 1504 to perform the functions as described herein. In another variation, aspects of the invention are implemented primarily in hardware using, for example, hardware components, such as application specific integrated circuits (ASICs). Implementation of the hardware state machine so as to perform the functions described herein will be apparent to persons skilled in the relevant art(s).

In yet another variation, aspects of the invention are implemented using a combination of both hardware and software.

1. A method for diagnosing a disease, the method comprising:
receiving, at a system, an image of a biological sample;
selecting one or more algorithms from a data repository associated with the system to obtain the diagnosis for the biological sample;
generating, by the system, the diagnosis for the biological sample based upon the outcome of the one or more algorithms when applied to the image of the biological sample; and
transmitting the diagnosis for the biological sample to a practitioner.

2. The method of claim 1, wherein selecting the one or more algorithms further comprises:
selecting a classification model for the disease, wherein the classification model comprises the one or more algorithms.

3. The method of claim 2, wherein the classification model further comprises at least one rule set for applying the one or more algorithms.

4. The method of claim 1, wherein the one or more algorithms are trained based upon image features associated with the disease.

5. A method for populating a data repository, the method comprising:
obtaining a registered spectral image and a visual image from a biological specimen;
receiving, at a system, annotation information for a selected annotation region for the registered spectral image;
associating the annotation information with a specific disease or condition; and
storing the visual image registered with the spectral image and the annotation information for the selected annotation region in an annotation file associated with the spectral image in a data repository associated with the system.

6. The method of claim 5, wherein the annotation information for the selected annotation region is automatically generated by the system.

7. The method of claim 6, wherein the annotation region is automatically selected by the system.

8. The method of claim 5, further comprising:
storing, in the data repository, meta-data associated with the registered spectral image and the visual image.

9. The method of claim 8, further comprising:
accessing the meta-data and the annotation information from the data repository; and
determining one or more correlations between the meta-data, the annotation information, and the specific disease or condition.

10. A system for diagnosing a disease, the system comprising:
a receiving module for receiving an image of a biological sample;
a selecting module for selecting one or more algorithms from a data repository associated with the system to obtain the diagnosis for the biological sample;
a generating module for generating the diagnosis for the biological sample based upon the outcome of the one or more algorithms when applied to the image of the biological sample; and
a transmitting module for transmitting the diagnosis for the biological sample to a practitioner.

11. The system of claim 10, wherein the selecting module is further configured to select a classification model for the disease, and
wherein the classification model comprises the one or more algorithms.

12. The system of claim 11, wherein the classification model further comprises at least one rule set for applying the one or more algorithms.

13. The system of claim 10, wherein the one or more trained algorithms are trained based upon image features associated with the disease.

14. A computer program product comprising a computer usable medium having control logic stored therein for causing a computer to diagnose a disease, the control logic comprising:
computer readable program code means for receiving an image of a biological sample;
computer readable program code means for selecting one or more algorithms from a data repository associated with the system to obtain the diagnosis for the biological sample;
computer readable program code means for generating the diagnosis for the biological sample based upon the outcome of the one or more algorithms when applied to the image of the biological sample; and
computer readable program code means for transmitting the diagnosis for the biological sample to a practitioner.

15. A method for analyzing biological specimens, comprising:
a) acquiring an original set of specimen data, the original set of specimen data comprising spectroscopic data of the biological specimen;
b) establishing a variance reduction order via hierarchical cluster analysis (HCA)
c) comparing the original set of specimen data to repository data, the repository data comprising data that is associated with at least one tissue or cellular class, wherein the at least one tissue or cellular class has spectroscopic features indicative of the same at least one tissue or cellular class;
d) determining whether a correlation exists between the original set of specimen data and the repository data associated with the at least one tissue or cellular class;
e) if it is determined that a correlation exists, generating a specimen data subset by labeling from the original set of specimen data, data that is not correlated with the repository data associated with the at least one tissue or cellular class, wherein the specimen data subset only includes data that is not labeled;
f) if it is determined that a correlation does not exist, providing a result of the analysis;
g) optionally repeating steps c) to f) with the specimen data subset generated in step e) according to the variance reduction order.

16. A method for creating algorithms for diagnosing a disease, the method comprising:
selecting one or more training features correlated to the disease or feature state and class of the disease, the one or more training features having an associated plurality of existing algorithms;
selecting at least one of the plurality of existing algorithms to use in creating a new algorithm;
determining an order of application of the at least one of the plurality of existing algorithms to diagnose the disease;
determining a plurality of rules sets for when to apply a particular algorithm from the plurality of existing algorithms based upon the determined order of application;
creating the new algorithm for diagnosing the disease based upon the plurality of rule sets; and
training the new algorithm to diagnose the disease by applying the plurality of rule sets to the one or more training features.

17. The method of claim 16, wherein the one or more training features are selected from one or more selected from a group consisting of visual data, spectral data, and clinical data.

18. The method of claim 16, wherein the one or more training features are correlated to a biochemical signature representative of the disease.

19. The method of claim 16, wherein the one or more training features are iteratively altered until the new algorithm produces an accurate diagnosis of the disease using the one or more training features.

20. The method of claim 16, wherein the training features are selected from one or more selected from a group consisting of a local data repository, a remote data repository, and published literature.
